(19) United States
(12) Patent Application Publication
(10) Pub. No.: US 2009/0020594 A1
(43) Pub. Date: Jan. 22, 2009

(54) DEVICE CONFIGURED TO PRESERVE, MAINTAIN AND/OR SAFEGUARD INFORMATION WITHIN AN ENVELOPE

(76) Inventor: Ralph Stamm, Blandon, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(21) Appl. No.: 12/173,101

(22) Filed: Jul. 15, 2008

Related U.S. Application Data
(60) Provisional application No. 60/959,788, filed on Jul. 17, 2007.

(51) Int. Cl. B65D 27/00; B42D 15/00

(52) U.S. Cl. 229/68.1; 283/100

(57) ABSTRACT

A device configured to preserve, maintain and/or safeguard information within an envelope includes a sheet of media having a first surface and an opposing second surface. The first surface includes security print covering substantially the entire first surface and having a predetermined pattern of indicia configured to prevent the deciphering of a writing on a composition proximate the media sheet.

### CROSS-REFERENCE TO RELATED APPLICATIONS

The present application claims the benefit of U.S. Provisional Patent Application No. 60/959,788, filed Jul. 17, 2007 and entitled “Security Insert”, the entire subject matter of which is hereby incorporated by reference.

### BACKGROUND OF THE INVENTION

This invention generally relates to identity theft prevention and to safeguarding, protecting and preserving sensitive and confidential business or personal information. More particularly, this invention relates to a device or security insert for use with a standard mailing envelope to preserve the confidentiality of business or personal information of letters, memos checks or other such objects or the identification of the contents within a sealed envelope.

It is generally known that mailing envelopes or packaging can come in a variety of shapes or sizes to accommodate various letters or mailings. Further, it is generally known that these envelopes may be constructed of virtually any type of material, but are often constructed of a relatively thick paper material to preserve the confidentiality of the material inside the sealed envelope. Some standard envelopes even include “security print” or indicia on an interior surface of the envelope to prevent the contents of a sealed envelope from being read from outside the envelope. However, these “security print” envelopes are generally more expensive to produce than standard non-security-type envelopes. Therefore, money is often wasted when a “security print” or security-type envelope is created and used for letters or mailings that do not contain sensitive or confidential information.

Therefore, it would be desirable to create a separate “security print” device or object capable of being inserted into a standard non-security print envelope to either enclose the contents, such as a letter or check, of the envelope with security print or block at least one side of the contents of the envelope, particularly the side that contains the sensitive business or personal information, within the envelope such that the personal information cannot be viewed from outside the sealed envelope. Specifically, it would be desirable to create a security insert that contains “security print” or a form of indicia on one or both sides of the security insert such that the insert can be placed next to or completely enclosing the material within the envelope to maintain the confidentiality of the material within the sealed envelope. Further, it would be desirable to create a security insert that is sized and shaped to easily and conveniently fit within a standard size envelope. Further, it would be desirable to create a security insert that can be manufactured inexpensively, quickly and easily and can be stored in a compact manner.

### BRIEF SUMMARY OF THE INVENTION

The present invention is directed to a device configured to preserve, maintain and/or safeguard information within an envelope. The device includes a sheet of media having a first surface and an opposing second surface. The first surface includes security print covering substantially the entire first surface and has a predetermined pattern of indicia configured to prevent the deciphering of a writing on a composition proximate the media sheet.

In another aspect, the present invention is directed to a device configured to preserve, maintain and/or safeguard information within an envelope. The device includes a sheet of media having a first surface and an opposing second surface. The first surface includes security means for preventing deciphering of a writing on a composition proximate said media sheet.

In yet another aspect, the present invention is directed to a device configured to preserve, maintain and/or safeguard information within an envelope. The device includes a sheet of media having a first surface and an opposing second surface, a top side, and a bottom side that opposes the top side and extends parallel to the top side. A right side extends perpendicular to the top and bottom sides. A left side opposes the right side and extends perpendicular to the top and bottom sides. The top and bottom sides have a length of approximately nine inches and the right and left sides have a length of approximately eight inches. The media further includes a predetermined fold line that extends from the right side to the left side at an approximate midsection of the right and left side. The fold line generally extends parallel to the top and bottom sides. A length of the right or left side measured from the fold line to the top side or the bottom side is approximately four inches. Security print covers the entire first surface. The security print is comprised of a predetermined pattern of indicia configured to prevent deciphering of a writing on a composition proximate the second surface. The second surface does not contain security print.

### BRIEF DESCRIPTION OF THE SEVERAL VIEWS OF THE DRAWINGS

The following detailed description of three preferred embodiments of the invention will be better understood when read in conjunction with the appended drawings. For the purpose of illustrating the invention, there are shown in the drawings three embodiments which are presently preferred. It should be understood, however, that the invention is not limited to the precise arrangements and instrumentalities shown.

In the drawings:

FIG. 1 is a rear right perspective view of an envelope found in the prior art;

FIG. 2 is a right side perspective view of a device in accordance with a first preferred embodiment of the present invention shown in side-by-side relation to a rear right side perspective view of the prior art envelope shown in FIG. 1;

FIG. 3 is a right side perspective view of the device shown in FIG. 2 in a partially unfolded position for clarity and with only portions of security means or print shown for ease of illustration;

FIG. 4 is a front perspective view of a device in accordance with a second preferred embodiment of the present invention shown in side-by-side relation to a front perspective view of the first preferred embodiment of the security insert shown in FIGS. 2 and 3, wherein only portions of the security means or prints are shown for ease of illustration;

FIG. 5 is a front perspective view of a device in accordance with a third preferred embodiment of the present invention shown in side-by-side relation to a front perspective view of the second preferred embodiment of the device shown in FIG. 4 and a front perspective view of the first preferred embodiment of the device shown in FIGS. 2 and 3, wherein only portions of the security means or prints are shown for ease of illustration;

FIG. 6A is an example of a second pattern used to form the security means or print;

FIG. 6B is an example of a third type of pattern used to form the security means or print; and

FIG. 6C is an example of a fourth type of pattern used to form the security means or print.

### DETAILED DESCRIPTION OF THE INVENTION

Certain terminology is used in the following description for convenience only, and is not limiting. The words “right,” “left,” “upper,” and “lower” designate directions in the drawings to which reference is made. The terminology includes the words above specifically mentioned, derivatives thereof, and words of similar import.

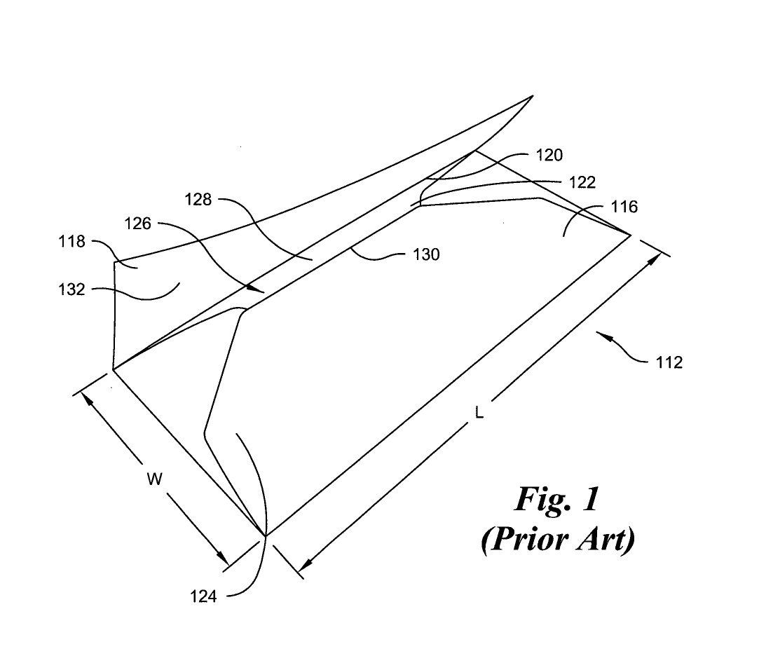

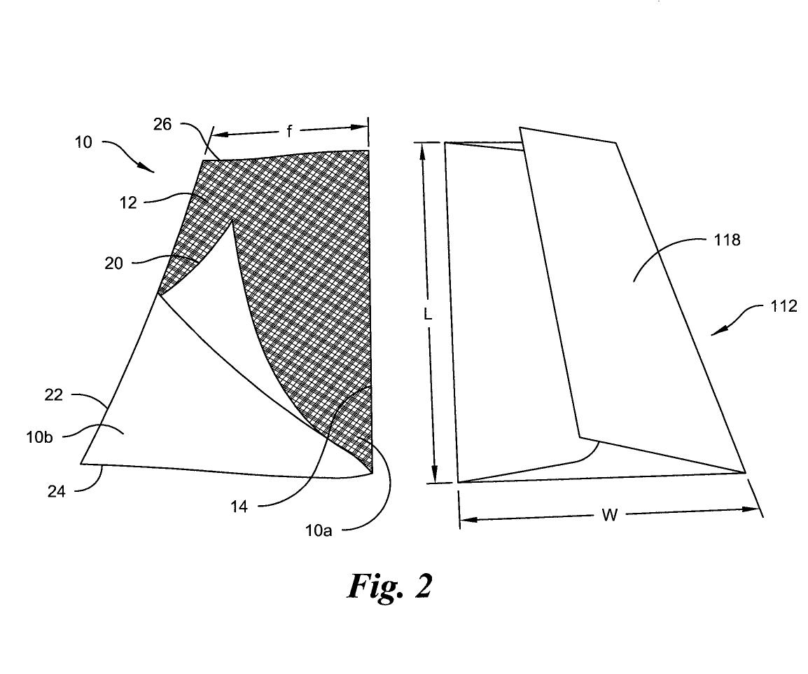

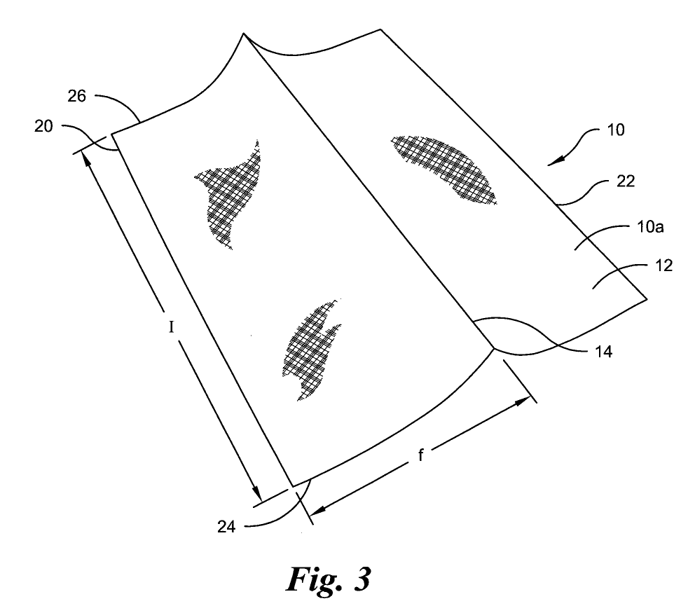

Referring to the drawings in detail wherein like numerals indicate like elements throughout, there is shown in FIGS. 2-3 a first preferred embodiment of a device configured to preserve, maintain and/or safeguard information within an envelope, indicated generally at 10, in accordance with the present invention. The device 10 may also be referred to as a “security insert” throughout this specification. The security insert 10 of the first preferred embodiment is preferably used in conjunction with a typical, non-security-type envelope, indicated generally at 112 and as shown in FIGS. 1 and 2, to preserve, maintain and/or safeguard information within the sealed envelope 112. The phrase “non-security-type envelope,” as used herein, is defined as any type of envelope, packaging or container that does not include “security print” or virtually any other form of security indicia on an inner surface of the envelope, packaging or container.

As seen in FIGS. 1 and 2, a standard non-security-type envelope 112 can be made of a variety of materials, such as paper (including a cellulose-based and/or pulp-based paper), paperboard, plastic, cardboard or other similar material. Typically envelopes 112 include a body portion 116 and a flap portion 118 that is pivotally coupled to the body portion 116 along a fold line 120. The envelope 112 has a predetermined length “L” and width “W” to accommodate most folded letters, checks or other such objects. The length “L” of the envelope 112 shown in FIGS. 1 and 2 is approximately nine and one half inches. The width “W” of the envelope 112 shown in FIGS. 1 and 2 is approximately four to four an one quarter inches. The body portion 116 of the envelope 112 may include a front panel 122 and rear panel 124 that defines a cavity 126 there between. The front panel 122 may include a standard “viewing window,” as is well known in the art. The cavity 126 includes a mouth 128 such that a letter, check or other similar object may be placed within the envelope 112 to be sent by mail. The flap portion 118 is pivotable about the fold line 120 between a closed position (FIG. 2) where the flap portion 118 covers the mouth 128 to generally seal the cavity 126 and an open position (FIG. 1) wherein the flap portion 118 does not cover the mouth 128 and does not generally seal the cavity 126. The flap portion 118 may be sized such that when the flap portion 118 is in the fully closed position (not shown) at least part of the flap portion 118 lies on top of and/or overlaps the rear panel 124. When the flap portion 118 is closed, the cavity 126 is bounded by the inner surface of the front panel 122, the inner surface of the rear panel 124 and part of the underside of the flap portion 118. The underside of the flap portion 118 may include an adhesive (not shown), such a moisture activated adhesive or pressure sensitive adhesive, or other securing means located thereon in position to secure the flap portion 118 to the rear panel 124.

It is understood by those skilled in the art that standard non-security-type envelopes 112 used in conjunction with the security insert 10 of the present invention may be any of a variety of envelopes of various shapes or sizes including legal, baronial, announcement, remittance, business, inter-office or other similar type envelope without departing from the spirit and scope of the invention. Further, the envelope 112 may be of any of a variety of styles of envelopes including, but not limited to, diagonal seam, center seam, side seam or single side seam-style constructed envelopes without departing from the spirit and scope of the invention. The material used to create standard non-security-type envelopes 112 is generally thin-enough or transparent-enough that information on the letter, check or other similar device within the sealed envelope 112 can be viewed when the entire envelope is held up to a light source.

The device 10 of the first preferred embodiment is formed of a sheet of media that is generally in the form of a rectangle in its completely flat and fully unfolded position (not shown), such as any unfolded or unbent piece of paper. As seen in FIGS. 2-3, the security insert 10 includes a first surface 10a and an opposite second surface 10b. Further, the security insert 10 includes a top side 20, a bottom side 22 that opposes the top side 20, a right side 24 generally extending perpendicular to the top and bottom sides 20, 22, and a left side 26 opposing the right side. The left side 26 also generally extends perpendicular to the top and bottom sides 20, 22. The length of the top and bottom side 20, 22 is slightly less than the length “L” of the standard envelope 112. Further, the length of the right and left sides 24, 26 of the security insert 10 in the fully unfolded position (not shown) is slightly less than twice the width “W” of the standard envelope 112. Thus, the overall size and shape of the security insert 10 allows the security insert 10 to be conveniently, quickly and easily inserting into and out of the standard envelope 112. However, it is within the spirit and scope of the invention that the size and shape of the security insert 10 be modified to conform to the size and shape of any other type of mailing envelope, packaging or container. For example, the security insert 10 may be circular or triangular in shape.

The security insert 10 of the first preferred embodiment preferably includes security means or security print 12, or a form of security indicia, on at least the first surface 10a of the security insert 10. The security means or security print 12 is formed of a predetermined pattern of indicia for preventing the deciphering of a writing on a composition proximate the securing insert 10 and preferably proximate to the second surface 10b of the device 10. The predetermined pattern is preferably repeated a predetermined number of times.

As seen in FIG. 2, the security print 12 preferably substantially or completely covers the entire first surface 10a of the security insert 10. The security print 12 is not shown to cover the entire first surface 10a in FIG. 3 for ease of illustration. Preferably, the security insert 10 of the first preferred embodiment does not include security print 12 or indicia on the second side surface 10b of the security insert 10. However, it is understood by those skilled in the art that the security insert 10 is not limited to having security print 12 on only one surface of the security insert 10 and may include security print 12 on either or both surfaces 10a, 10b of the security insert 10. Further, it is within the spirit and scope of the invention that either surface 10a, 10b of the security insert 10 have security print 12 and that only specific locations on either surface 10a, 10b (see FIG. 3, for example) of the security insert 10 include security means or security print 12 to reduce the overall costs associated with producing the security insert 10 while still maintaining the confidentiality of portions of the letter, check or other similar device within the sealed envelope 112.

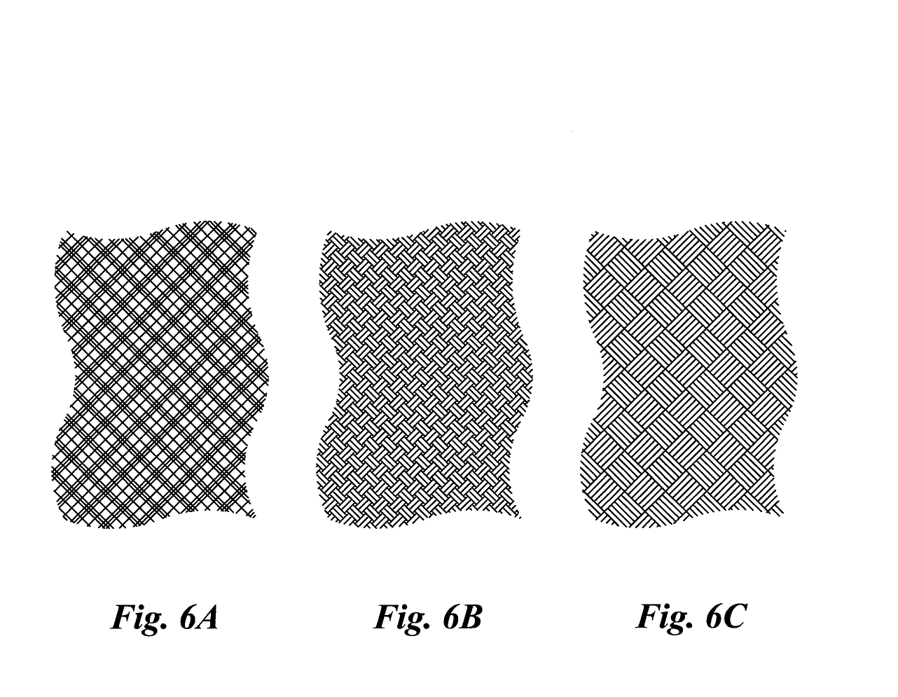

Further, it is understood by those skilled in the art that the security means, security print 12 or indicia on the front surface 10a of the security insert 10 can take any of a variety of forms, such as text, images, drawings, photographs, notices, advertisements or any other similar indicia without departing from the spirit and scope of the invention. See FIGS. 6A-6C for various examples. Further, for example, the manufacturer or user may find it profitable to allow a business or corporation to place their company logo or an advertisement on the blank, second surface 10b of the security insert 10. Further, it is within the spirit and scope of the present invention that the text, images, drawings, photographs, notices, advertisements or other similar indicia place on the security insert 10 are changed seasonally, for instance, to represent a particular event, such as a holiday, occurring at that time.

The security insert 10 further includes a predetermined fold line 14 generally at the midsection in a width direction of the security insert 10 such that the security insert 10 can be folded around the material to be mailed, such as a letter, check or other similar device, to preserve the confidentiality of the information contained on the material. Specifically, the fold line 14 extends from the right side 24 to the left side 26 at an approximate midsection of the right and left sides 24, 26 and the fold line 14 generally extends parallel to the top and bottom sides 20, 22. When the security insert 10 is folded such that the top surface 20 of the security insert 10 is aligned with the bottom surface 22, the security insert 10 has a folded width “f”. The length of folded width “f” of the security insert 10 is slightly less than the length of width “W” of the envelope 112 (approximately four inches, four example) to assure that the security insert 10 may be easily inserted and removed from within the envelope 112. It is understood by those skilled in the art that the fold line 14 may be entirely created by the consumer or user or that the manufacturer may crease or pre-fold the security insert 10 along the fold line 14.

The media used to form the security insert 10 of the first preferred embodiment may be made of any of a variety of materials, including sheets of thin or flexible material, such as paper, glossy paper, paperboard, plastic or polymeric material, cardboard or other similar material capable of having printed indicia or security print 12 mounted thereon or integrally printed therein without departing from the spirit and scope of the invention. The media is preferably formed of a relatively inexpensive and generally transparent material when it does not contain the security means or security print 12. The material used to construct the security insert 10 allows for a multitude of security inserts 10 to be neatly and compactly stored, such as packaged printed paper. However, it is understood by those skilled in the art that the security inserts 10 may be stored or packaged in a completely folded position (not shown). Further, the material used to construct the security insert 10 is preferably inexpensive such that is neither expensive nor burdensome to keep security inserts 10 in stock to protect and maintain the confidentiality of sensitive information to be mailed in standard non-security-type envelopes 112. Thus, even if a company or business has supplied a non-security-type envelope 112 to the consumer or user for returning a letter, check or other similar device to the company, the user can preserve the confidential nature of the information on that letter, check, etc., by including a security insert 10 within the envelope 112.

In operation, the security insert 10 of the first preferred embodiment is used in conjunction with a standard non-security-type envelope. Specifically, a consumer or user would fold the letter, check or other similar device (not shown) that they desire to preserve, maintain or safeguard the information printed thereon as normally would be required to fit within the envelope 112. Once the letter (not shown) is folded to the required size, the user would take a single security insert 10 from the conveniently stacked and stored pile (not shown) and place the security insert 10 over the letter such that the second surface 10b is in facing engagement with the letter. The user would then fold the security insert 10 over the folded letter such that the top side 20 is flush with the bottom side 22. In this configuration, the first surface 10a of the security insert 10 is on the opposite side of the security insert 10 from the letter.

Next, the assembled security insert 10 and letter are placed within the envelope 112 as the letter would normally be placed within the envelope 112 and the envelope is sealed by adhering the flap portion 118 to the rear panel 124. However, with the addition of the security insert 10 surrounding the letter, an individual from outside the sealed envelope 112 cannot read the confidential information on the letter. Thus, the consumer or user does not require a security print envelope because the security insert 10 of the present invention prevents information from being seen outside the sealed envelope 112. Although it is preferred that the security insert 10 is folded over the folded letter such that the side without the security print 12 is facing the letter, namely the second surface 10b, it is within the spirit and scope of the invention that that the first surface 10a, which includes the security print 12, may be folded to be in facing engagement with the letter. Further, it is understood by those skilled in the art that the object desired to be mailed does not have to be folded if it can fit within the envelope 112 without needing to be folded, bent or crumpled.

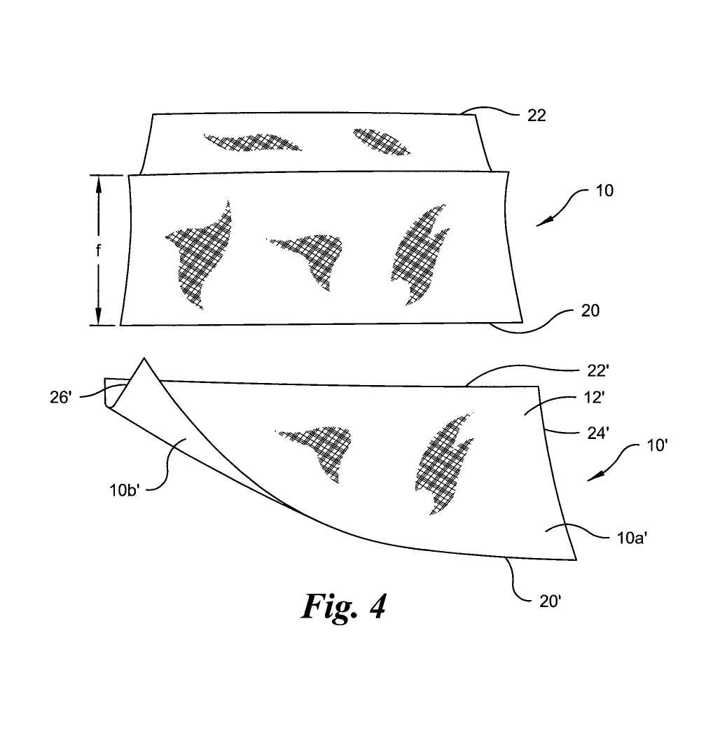

Referring to FIG. 4, a second preferred embodiment of the device or security insert 10′ is shown, including like reference numerals to indicate like elements and a prime symbol (′) distinguishing the reference numerals of the second preferred embodiment from the first preferred embodiment. The device or security insert 10′ is substantially similar to the device or security insert 10 of the first preferred embodiment. Similar to the first preferred embodiment, the second preferred embodiment of the security insert 10′ is preferably used in conjunction with a typical non-security-type envelope, indicated generally at 112 and as shown in FIGS. 1 and 2, to preserve, maintain and/or safeguard information within the sealed envelope 112. However, the right side 24′ and left side 26′ of the security insert 10′ of the second preferred embodiment preferably have a length generally equal to the folded width “f” of the security insert 10 of the first preferred embodiment. However, it is understood by those skilled in the art that the size and shape of the security insert 10′ of the second preferred embodiment may be modified without departing from the spirit and scope of the present invention.

As seen in FIG. 4, similar to the security insert 10′ of the first preferred embodiment, the security insert 10′ of the second preferred embodiment includes security means, security print 12′ or security indicia on only the first surface 10a′ of the security insert 10′. Preferably, the security means or security print 12′ covers substantially the entire first surface 10a′ or the entire first surface 10a′ of the device 10′. Please note that FIG. 4 only shows portions of the first surface 10a′ covered in security means or security print 12′ for ease of illustration. Further, the second surface 10b′ of the security insert 10 is blank, or in the form of plain paper for example, to reduce to overall production costs associated with created and manufacturing the security insert 10′. Similar to the first preferred embodiment, the top side 20′ and bottom side 22′ of the security insert 10′ of the second preferred embodiment are preferably slightly less in length than the length “L” of the standard envelope 112.

In operation, the security insert 10′ of the second preferred embodiment does not need to be folded as does the security insert 10 of the first preferred embodiment. The security insert 10′ of the second preferred embodiment can merely be placed within the envelope next to the letter, check or other similar device before the envelope 112 is sealed to preserve the confidentiality or sensitivity of business or personal information on the letter, check or other similar device.

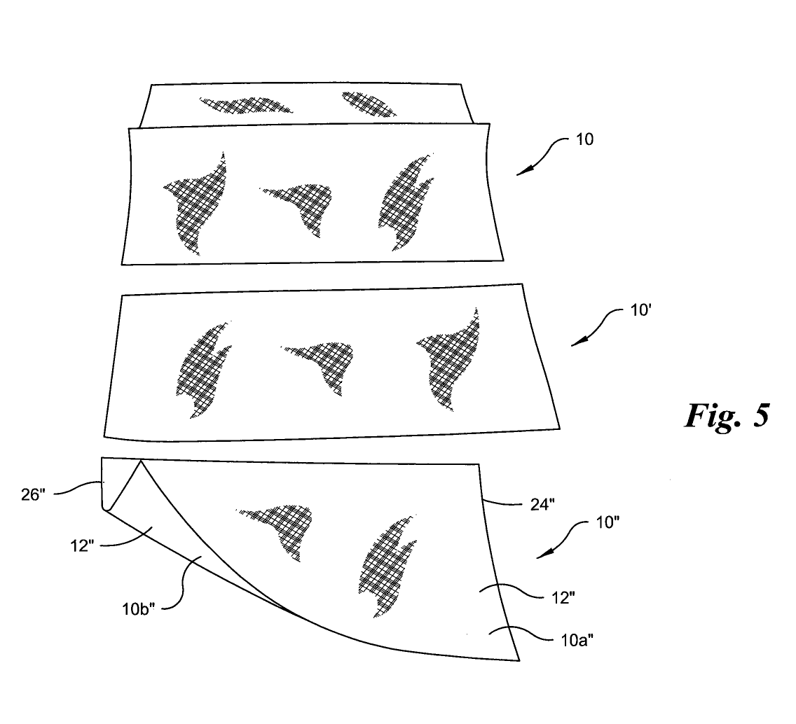

Referring to FIG. 5, a third preferred embodiment of the device or security insert 10″ is shown, including like reference numerals to indicate like elements and two prime symbols (″) distinguishing the reference numerals of the third preferred embodiment from the first and second preferred embodiments. The device or security insert 10″ of the third preferred embodiment is substantially similar to the device or security inserts 10, 10′ of the first and second preferred embodiments. Similar to the first and second preferred embodiments, the third preferred embodiment of the security insert 10″ is preferably used in conjunction with a typical non-security-type envelope, indicated generally at 112 and as shown in FIGS. 1 and 2, to preserve, maintain and/or safeguard information within the sealed envelope 112.

Similar to the security insert 10′ of the second preferred embodiment, length of the right side 24″ and left side 26″ of the security insert 10″ of the third preferred embodiment have a length generally equal to the folded width “f” of the security insert 10 of the first preferred embodiment. However, the length of the top side 20″ and the bottom side 22″ is preferably substantially less than the length “L” of the envelope 112 to accommodate the size of a small envelope (not shown) such that the security insert 10″ does not need to be folded to fit inside. However, it is understood by those skilled in the art that the size and shape of the security insert 10″ of the third preferred embodiment may be modified, such that the security insert 10″ of the third preferred embodiment is substantially similar in size to the security insert 10, 10′ of the first and second preferred embodiments, without departing from the spirit and scope of the present invention.

As seen in FIG. 5, the device or security insert 10″ of the third preferred embodiment includes security means, security print 12″ or security indicia on both the first surface 10a″ and second surface 10b″ of the security insert 10″. The security insert 10″ of the third preferred embodiment contains security print 12″ on both surfaces 10a″, 10b″ to make it increasingly difficult to view the contents of the sealed envelope 112 when holding the envelope 112 next to a light source. Preferably, the security means or security print 12″ covers substantially the entire first and surfaces 10a″, 10b″ or the entire first and surfaces 10a″, 10b″ of the device 10″. Please note that FIG. 5 only shows portions of the first and second surfaces 10a″, 10b″ covered in security means or security print 12″ for ease of illustration. In operation, the security insert 10″ of the third preferred embodiment is used in the same way as the security insert 10′ of the second preferred embodiment.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as described by the appended claims.

I/We claim:

1. A device configured to preserve, maintain and/or safeguard information within an envelope, said device comprising:
a sheet of media having a first surface and an opposing second surface, said first surface including security print covering substantially the entire first surface and being comprised of a predetermined pattern of indicia configured to prevent the deciphering of a writing on a composition proximate said media sheet.

2. The device in accordance with claim 1, wherein said second surface also includes security print.

3. The device in accordance with claim 1, the sheet further comprising:
a top side;
a bottom side opposing said top surface;
a right side generally extending perpendicular to said top and bottom sides;
a left side opposing said right side, said left side generally extending perpendicular to said top and bottom sides; and
a predetermined fold line extending from said right side to said left side at an approximate midsection of said right and left sides, said fold line generally extending parallel to said top and bottom sides.

4. The device in accordance with claim 3, wherein a length of said right and left sides measured from said fold line to said top side is approximately four inches.

5. The device in accordance with claim 1, wherein said media is formed of paper.

6. The device in accordance with claim 1, wherein said media is formed of a polymeric material.

7. The device in accordance with claim 1, wherein said predetermined pattern is repeated a predetermined number of times.

8. A device configured to preserve, maintain and/or safeguard information within an envelope, said device comprising:
a sheet of media having a first surface and an opposing second surface, said first surface including security means for preventing deciphering of a writing on a composition proximate said media sheet.

9. The device in accordance with claim 8, wherein said security means covers substantially the entire first surface.

10. The device in accordance with claim 9, wherein said second surface also includes said security means.

12. The device in accordance with claim 8, the sheet further comprising:
a top side;
a bottom side opposing said top surface;
a right side generally extending perpendicular to said top and bottom sides;
a left side opposing said right side, said left side generally extending perpendicular to said top and bottom sides; and
a predetermined fold line extending from said right side to said left side at an approximate midsection of said right and left sides, said fold line generally extending parallel to said top and bottom sides, wherein a length of said right or left side measured from said fold line to said top side or said bottom side is approximately four inches.

13. The device in accordance with claim 8, wherein said media is formed of paper.

14. The device in accordance with claim 8, wherein said media is formed of a polymeric material.

15. A device configured to preserve, maintain and/or safeguard information within an envelope, said device comprising:
a sheet of media having a first surface and an opposing second surface, a top side, a bottom side opposing said top side and extending parallel to said top side, a right side extending perpendicular to said top and bottom sides, a left side opposing said right side and extending perpendicular to said top and bottom sides, wherein said top and bottom sides have a length of approximately nine inches and said right and left sides have a length of approximately eight inches,
said media further including a predetermined fold line extending from said right side to said left side at an approximate midsection of said right and left side, said fold line generally extending parallel to said top and bottom sides, wherein a length of said right or left side measured from said fold line to said top side or said bottom side is approximately four inches;
wherein said first surface includes security print covering said entire first surface, said security print being comprised of a predetermined pattern of indicia configured to prevent deciphering of a writing on a composition proximate said second surface;
and wherein said second surface does not contain security print.

16. The device in accordance with claim 15, wherein said media is paper.

17. The device in accordance with claim 15, wherein said media is a polymeric material.

18. The device in accordance with claim 15, wherein said predetermined pattern is repeated a predetermined number of times.

19. The device in accordance with claim 15, wherein said sheet of media is generally transparent.
